(19) United States
(12) Patent Application Publication
(10) Pub. No.: US 2007/0216180 A1
(43) Pub. Date: Sep. 20, 2007

(54) Front cowl trim for headlights

(75) Inventors: Bradley J. Hanson, North Augusta, SC (US); John Herrick, Evans, GA (US); Kent H. Bruntz, Evans, GA (US); Donald S. Hanson JR., Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/376,688

(22) Filed: Mar. 15, 2006

(51) Int. Cl. B60J 9/00

(52) U.S. Cl. 296/1.08

(57) ABSTRACT

The present teachings further provide for a cowl trim for a golf car or light utility vehicle including: a first aperture; a second aperture; a first headlight mounted within the first aperture; and a second headlight mounted within the second aperture.

### FIELD

The present disclosure relates to a method and apparatus for a golf car.

### BACKGROUND

The statements in this section merely provide background information related to the present disclosure and may not constitute prior art.

Golf cars are often provided with headlights. Golf cars equipped with headlights often have a front cowl designed to include apertures and other features to accommodate headlights. Such cowls are typically not suited for use in applications where headlights are not provided. Thus, conventional golf cars typically require two front cowl designs, one design that can accommodate headlights and another design that can be used when headlights are not provided. While conventional designs and methods for providing golf cars with headlights are suitable for their intended uses, they are subject to improvement.

### SUMMARY

The present teachings provide for a rear body; a front cowl opposite the rear body; a trim assembly mounted to the front cowl; an aperture in the trim assembly; and a headlight mounted within the aperture.

The present teachings further provide for a cowl trim for a golf car including: a first aperture; a second aperture; a first headlight mounted within the first aperture; and a second headlight mounted within the second aperture.

The present teachings also provide for a golf car including: a front cowl; a cowl trim mounted to said front cowl, and a headlight mounted to said cowl trim. Said cowl trim includes a top portion; a top flange of said top portion, said top flange in flexible contact with said front cowl; a bottom portion opposite said top portion; a first side portion rigidly mounted to said front cowl; and a second side portion opposite said first side portion, said second side portion rigidly mounted to said front cowl.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front view of a golf car according to various embodiments;

FIG. 2 is a side view of the golf car;

FIG. 3 is a top view of a front cowl and front cowl trim of the golf car;

FIG. 4 is a side view of the front cowl and the front cowl trim;

FIG. 5 is a front view of the cowl trim;

FIG. 6 is a rear view of the cowl trim;

FIG. 7 is a top view of the cowl trim;

FIG. 8 is a bottom view of the cowl trim;

FIG. 9 is a side view of the cowl trim;

FIG. 10 is a cross-sectional view taken along line 10-10 of FIG. 4;

FIG. 11 is a rear view of the cowl trim with headlights mounted to the cowl trim;

FIG. 12 is a perspective view of the front cowl of the golf car without the cowl trim; and

FIG. 13 is a perspective view of a fastening clip used to mount the cowl trim to the front cowl.

### DETAILED DESCRIPTION

The following description is merely exemplary in nature and is in no way intended to limit the present disclosure, application, or uses. Throughout this specification, like reference numerals will be used to refer to like elements.

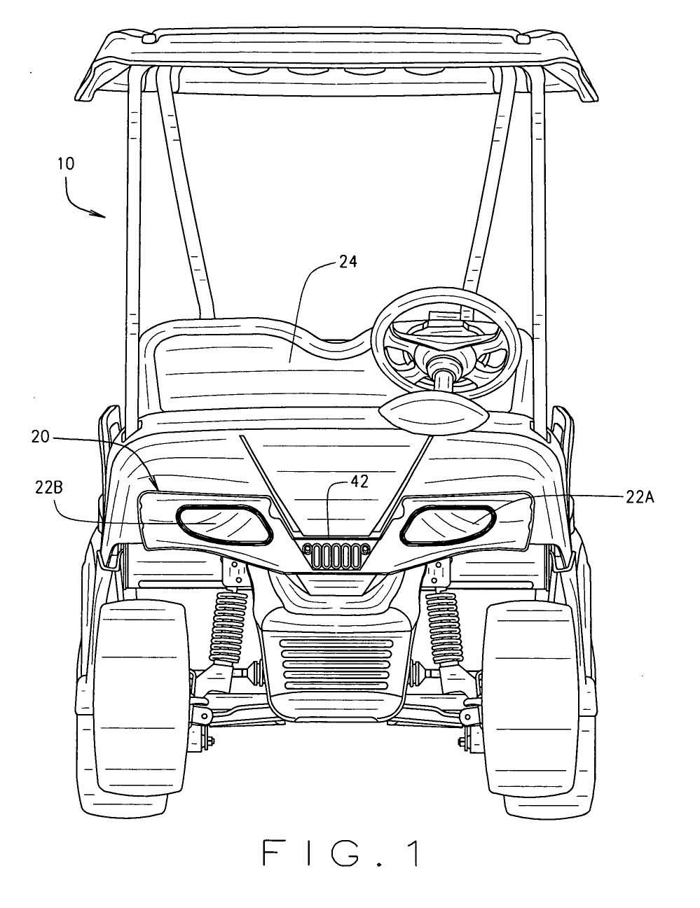

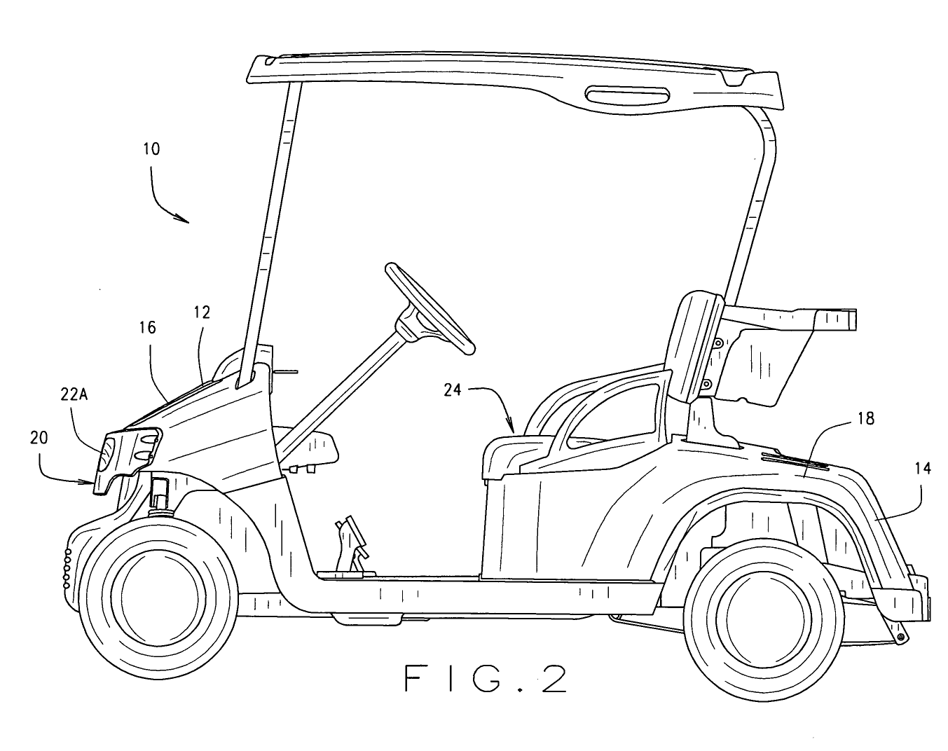

A golf car according to the present teachings is illustrated in FIGS. 1 and 2 at reference numeral 10. The golf car 10 can include a front end 12 and a rear end 14 that can be opposite to the front end 12. The front end 12 can include a front cowl 16 and the rear end 14 can include a rear body 18.

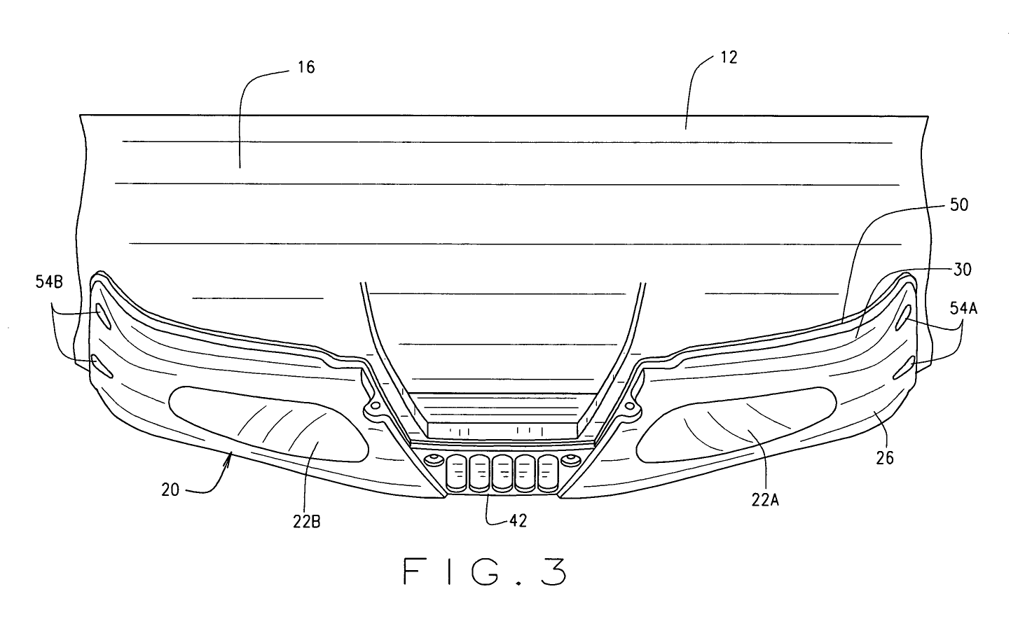

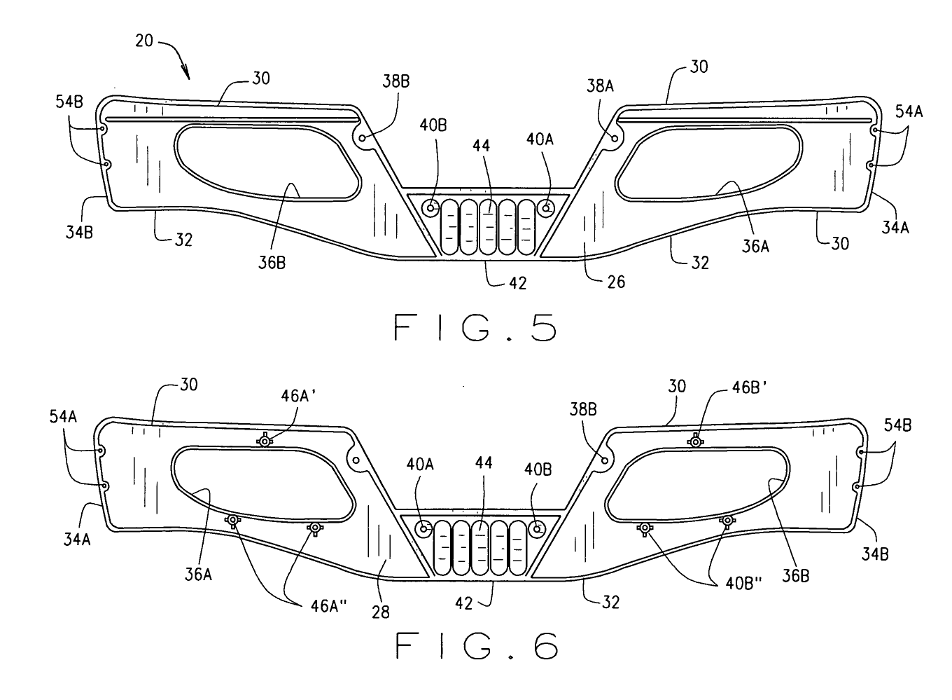

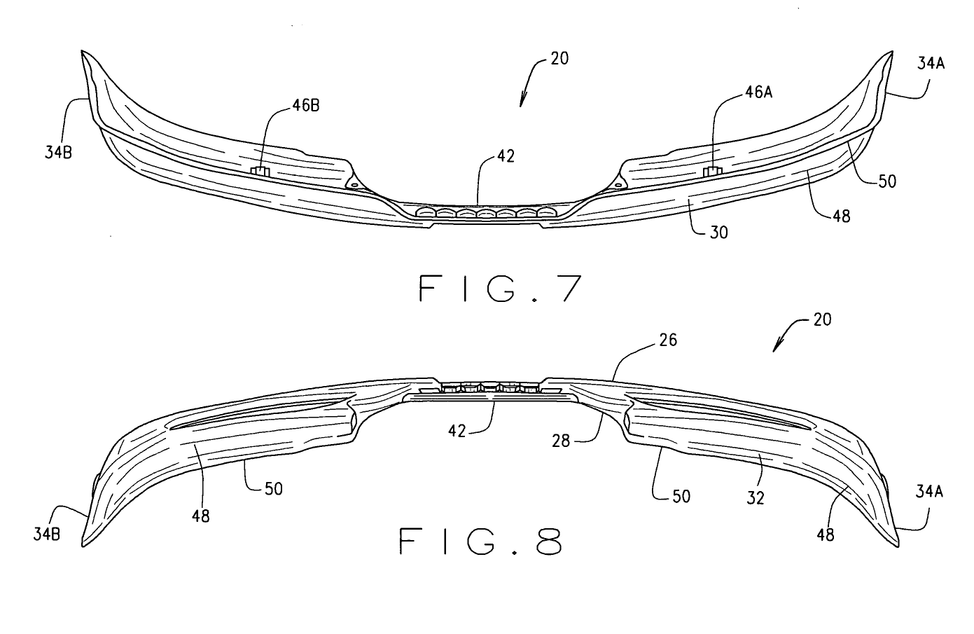

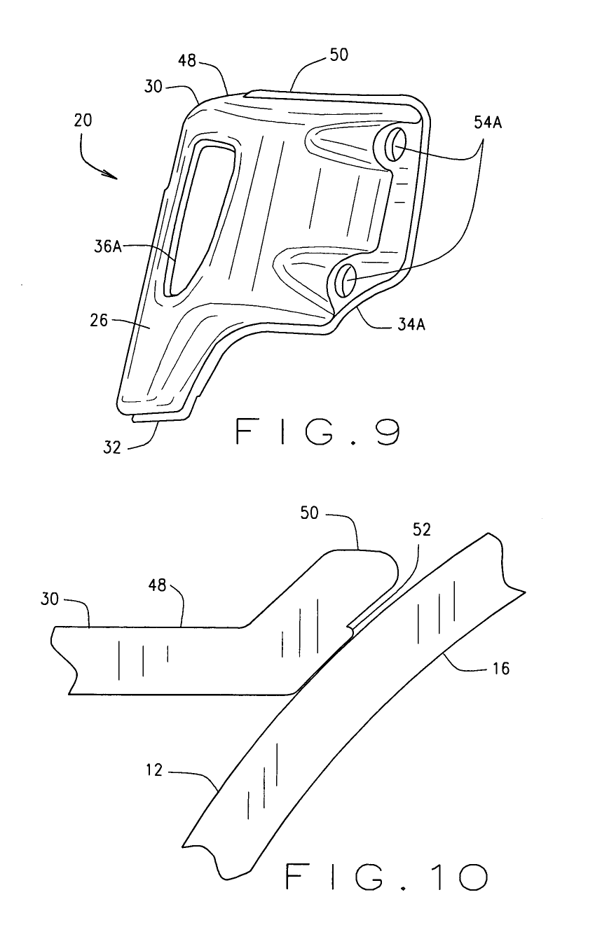

A front cowl trim 20 can be mounted to the front cowl 16. A first headlight 22A and a second headlight 22B can be mounted to the front cowl trim 20. A seat assembly 24 can be mounted to the rear body 18. With additional reference to FIGS. 3 through 9, the front cowl trim 20 can include a front portion 26, a rear portion 28, a top portion 30, a bottom portion 32, a first side portion 34A, and a second side portion 34B. With particular reference to FIGS. 5 and 6, the front portion 26 and the rear portion 28 can include a first aperture 36A and a second aperture 36B. The first aperture 36A can be proximate to the first side portion 34A and the second aperture 36B can be proximate to the second side portion 34B. The first and the second apertures 36A and 36B can extend through the cowl trim 20 from the front portion 26 to the rear portion 28. The first and the second apertures 36A and 36B can be of any suitable shape or size to accommodate the first and second headlights 22A and 22B respectively.

The front portion 26 and the rear portion 28 can further include a series of through holes operable to receive suitable fasteners. For example, a first set of through holes 38A and 38B can extend through the cowl trim 20 from the front portion 26 to the rear portion 28. The through holes 38A and 38B can be proximate to the top portion 30 of the cowl trim 20. Further, the through hole 38A can be proximate to the first aperture 36A and the through hole 38B can be proximate to the second aperture 36B. The through holes 38A and 38B can be any suitable through holes operable to receive a suitable fastener for securing the cowl trim 20 to the front cowl 16.

The front portion 26 and the rear portion 28 can further include a second set of through holes 40A and 40B. The second set of through holes 40A and 40B can each extend through the cowl trim 20 from the front portion 26 to the rear portion 28. The through holes 40A and 40B can be located between the bottom portion 32 and the first set of through holes 38A and 38B. The through holes 40A and 40B can be any suitable through holes operable to receive a suitable fastener for securing the cowl trim 20 to the front cowl 16.

The front cowl trim 20 can further include a center portion 42 between the first and the second apertures 36A and 36B. The second set of through holes 40A and 40B can be located in the center portion 42. The center portion 42 can include, at the front portion 26 of the front cowl trim assembly, one or more depressions 44, which can resemble slits in a vehicle grill. The depressions 44 can also be provided at the rear portion 28 (FIG. 6) of the front cowl trim 20.

As illustrated in FIG. 6, the rear portion 28 can include the first set of through holes 38A and 38B, the second set of through holes 40A and 40B, and the depressions 44 of the center portion 42. The rear portion 28 can further include one or more first bosses 46A and one or more second bosses 46B. The first bosses 46A and the second bosses 46B can be any suitable fastening feature, such as a receptacle for receiving a fastener, that can facilitate mounting of the cowl trim 20 to the front cowl 16. The first bosses 46A can be similar to the second bosses 46B.

The first bosses 46A can be located around the first aperture 36A. As illustrated, one boss 46A′ can be positioned between the first aperture 36A and the top portion 30 and two bosses 46A″ can be positioned between the first aperture 36A and the bottom portion 32. The second bosses 46B′ can be located around the second aperture 36B. As illustrated, one boss 46B′ can be positioned between the second aperture 36B and the top portion 30 and two bosses 46B″ can be positioned between the second aperture 36B and the bottom portion 32.

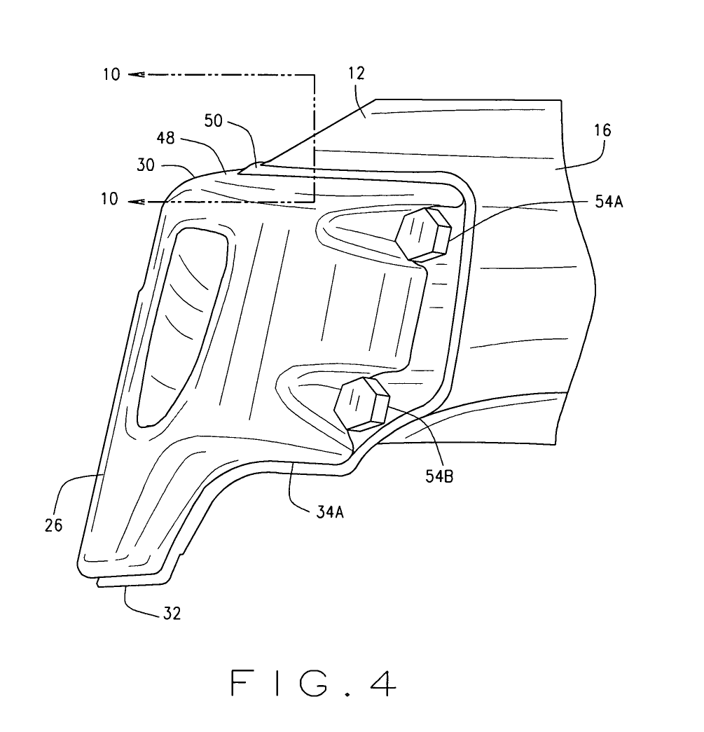

As illustrated in FIGS. 4, 7, 9, and 10 for example, the top portion 30 can include a top surface 48 and a top flange 50. The top surface 48 can be integral with the top flange 50. The top flange 50 can extend from the top surface 48 at an angle relative to the top surface 48. The top flange 50 can include a rear flange 52 (FIG. 10) that can protrude from the top flange 50. The rear flange 52 can protrude from the top flange 50 at a side of the top flange 50 opposite to the front portion 26. The rear flange 52 can be generally planar with the top surface 48.

With reference to FIGS. 5-9, the first side portion 34A and the second side portion 34B can extend approximately perpendicular to the center portion 42 of the cowl trim 20. The first and second side portions 34A and 34B can be positioned at any angle relative to the remainder of the cowl trim 20 to provide the cowl trim 20 with a shape that corresponds to the shape of the front cowl 16.

The first side portion 34A can include one or more first side apertures 54A. The first side apertures 54A can be recessed within the first side portion 34A. The first side apertures 54A can have any suitable size or shape operable to accommodate a suitable fastener to secure the first side portion 34A to the front cowl trim 20.

The second side portion 34B can include one or more second side apertures 54B. The second side apertures 54B can be recessed within the second side portion 34B. The second side apertures 54B can be similar to the first side apertures 54A and can have any suitable size or shape operable to accommodate a suitable fastener to secure the second side portion 34B to the front cowl trim 20.

The front cowl trim assembly 20 can be made of any suitable material. For example, the front cowl trim assembly 20 can be made of a mineral filled polypropylene. One example of a mineral filled polypropylene that can be used is a talc-filled polypropylene.

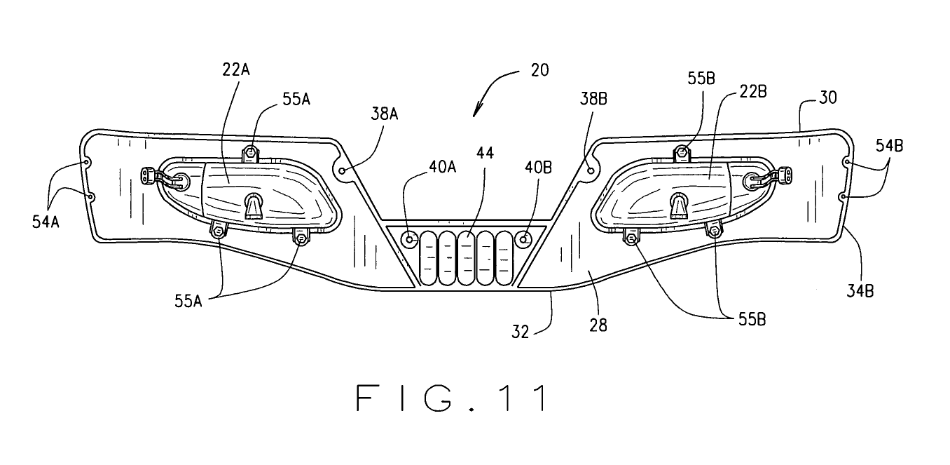

With additional reference to FIG. 11, the first and the second headlights 22A and 22B can be mounted to the rear portion 28 of the cowl trim 20 at the first and the second apertures 36A and 36B respectively. The first headlight 22A can be mounted at the first aperture 36A using a suitable fastening device 55A operable to engage both the first headlight 22A and the first bosses 46A. The second headlight 22B can be mounted to the second aperture 36B using a suitable fastening device 55B operable to engage both the second headlight 22B and the second bosses 46B.

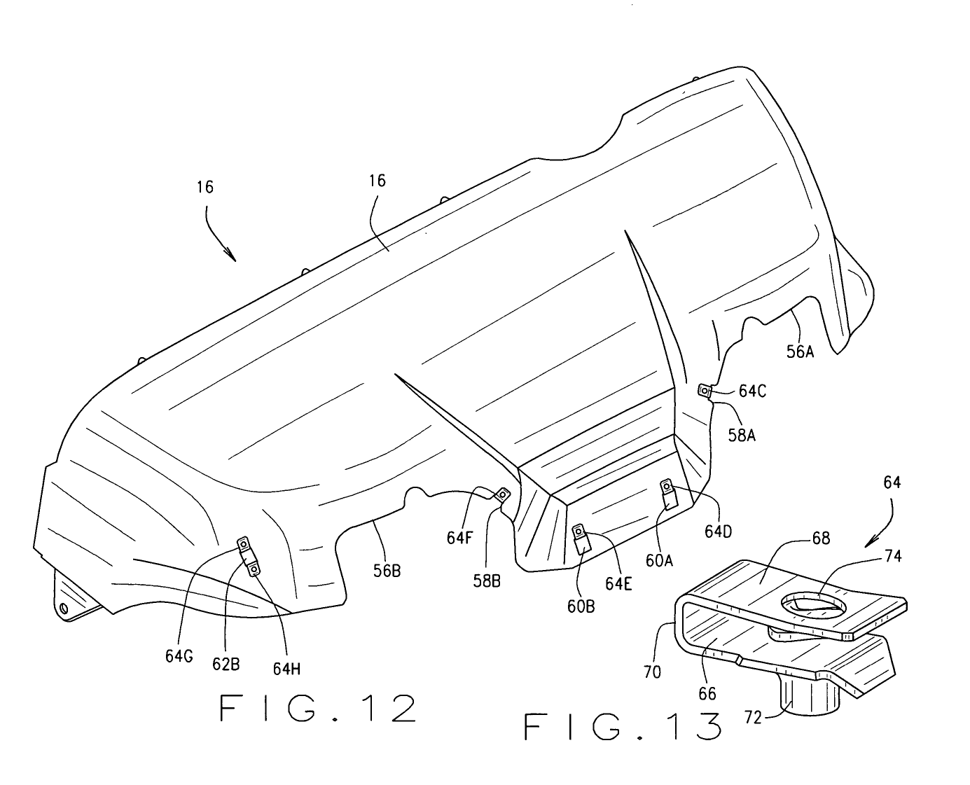

With reference to FIG. 12, the front cowl 16 can include a first cut-out portion 56A and a second cut-out portion 56B. The first cut-out portion 56A can be positioned and sized to accommodate the first headlight 22A. The second cut-out portion 56B can be positioned and sized to accommodate the second headlight 22B.

The front cowl 16 can further include at least one first mount 58, at least one second mount 60, a first side mount (not shown), and a second side mount 62B. Each of the mounts 58, 60, and 62B can be holes or openings in the front cowl 16. As illustrated, the front cowl 16 can include two first mounts 58A and 58B. The first mount 58A can be at the first cut-out portion 56A. The first mount 58B can be at the second cut-out portion 56B. Each of the first mounts 58A and 58B can be positioned to be in alignment with one of the first through holes 38A and 38B respectively when the cowl trim 20 is mounted to the front cowl 16.

As illustrated, the front cowl 16 can include two second mounts 60A and 60B. The two second mounts 60A and 60B can be positioned spaced apart between the first and the second cut-out portions 56A and 56B. The two second mounts 60A and 60B can be positioned to be in alignment with a different one of the second through holes 40A and 40B respectively when the cowl trim 20 is mounted to the front cowl 16.

The first side mount and the second side mount 62B can be substantially similar. The first side mount and the second side mount 62B can be located at opposite sides of the front cowl 16. For example, the first side mount can be located at a side of the front cowl 16 proximate to the first cut-out portion 56A. The second side mount 62B can be located at a side of the front cowl 16 proximate to the second cut-out portion 56B. The first side mount can be positioned so that the first side apertures 54A of the cowl trim 20 can be at least substantially aligned with the first side mount when the front cowl trim 20 is mounted to the front cowl 16. The second side mount 62B can be positioned so that the second side apertures 54B can be at least substantially aligned with the second side mount 62B when the front cowl trim 20 is mounted to the front cowl 16.

Each of the first mounts 58, the second mounts 60, the first side mount, and the second side mount 62B can include a fastening clip 64. As illustrated in FIG. 13, each fastening clip 64 can include a first flange 66 and a second flange 68. The first flange 66 can be connected to the second flange 68 by a base portion 70. The first flange 66 can include a receptacle 72. The receptacle 72 can include internal threads for cooperation with a fastener. The second flange 68 can include an opening 74.

One of the fastening clips 64A-H can be secured to the front cowl 16 at each of the first mounts 58 and the second mounts 60. Two fastening clips 64 can be secured to each of the first side mount and the second side mount 62B. Each of the fastening clips 64 can be secured to the front cowl 16 such that the front cowl 16 is seated between the first flange 66 and the second flange 68.

With the first and second headlights 22A and 22B mounted to the cowl trim 20, the cowl trim 20 can be mounted to the front cowl 16 at the front end 12 of the car 10. The cowl trim 20 can be positioned such that the first through holes 38A and 38B are aligned with the fastening clips 64C and 64F at the first mounts 58A and 58B, respectively; the second through holes 40A and 40B are aligned with the fastening clips 64D and 64E at the second mounts 60A and 60B respectively; the first side apertures 54A are aligned with the fastening clips 64A and 64B at the first side mount; and the second side apertures 54B are aligned with the fastening clips 64G and 64H at the second side mount 62B.

The cowl trim 20 can be mounted to the front cowl 16 using suitable fasteners extending through each of the first set of through holes 38A and 38B, the second set of through holes 40A and 40B, the first side apertures 54A, and the second side apertures 54B to engage the fastening clips 64 at each of the first mounts 58A and 58B, the second mounts 60A and 60B, the first side mount, and the second side mount 62B. The fasteners, which can be threaded, can be secured to the fastening clips 64 by inserting the fasteners through the opening 74 and into cooperation with the threads of the receptacle 72. As the fasteners are inserted through the opening 74 and into cooperation with the threads of the receptacle 72, the fasteners punch holes in the front cowl 16 to secure the trim 20 to the front cowl 16.

With reference to FIG. 10, the cowl trim 20 can be mounted to the front cowl 16 such that the rear flange 52, which extends from the top flange 50, directly abuts the front cowl 16. The rear flange 52 need not be rigidly secured to the front cowl 16 and need not be mounted at a specific point on the front cowl 16. Therefore, the rear flange 52 can accommodate any mismatch between the cowl trim 20 and the front cowl 16.

The front cowl trim 20 can be mounted to most any golf car or light utility vehicle to provide the car with headlights. The front cowl trim 20 can eliminate the need for multiple front cowl designs, such as a design that can accommodate headlights and a design for use in applications without headlights. Thus, the front cowl trim 20 can save engineering and manufacturing resources.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A vehicle comprising:
a rear body;
a front cowl opposite said rear body;
a trim assembly mounted to said front cowl;
an aperture in said trim assembly; and
a headlight mounted within said aperture, wherein the vehicle is one of a golf car or light utility vehicle.

2. The apparatus of claim 1, wherein said trim assembly comprises mineral filled polypropylene.

3. The apparatus of claim 1, wherein said trim assembly comprises talc-filled polypropylene.

4. The apparatus of claim 1, wherein said trim assembly comprises a boss and said headlight is mounted to said boss.

5. The apparatus of claim 1, wherein said trim assembly comprises at least one through hole, said through hole accepting a fastener for fastening said trim assembly to said front cowl.

6. The apparatus of claim 1, wherein said trim assembly comprises a center portion comprising a depressed surface.

7. The apparatus of claim 1, wherein trim assembly comprises a first side portion comprising a first side aperture; and
wherein said trim assembly comprises a second side portion comprising a second side aperture.

8. The apparatus of claim 1, wherein said trim assembly comprises a center portion, a first side portion, and a second side portion;
wherein said first side portion and said second side portion are each orientated about 90° to said center portion.

9. The apparatus of claim 1, wherein said trim assembly comprises a top surface and a top flange extending from said top surface, said top flange in flexible contact with said front cowl.

10. The apparatus of claim 9, wherein said trim assembly comprises a rear flange extending from said top flange, said top flange in direct contact with said front cowl.

11. A cowl trim comprising:
a first aperture;
a second aperture;
a first headlight mounted within said first aperture; and
a second headlight mounted within said second aperture, wherein the cowl trim is mounted to one of a golf car or light utility vehicle.

12. The cowl trim of claim 11, wherein said cowl trim comprises mineral filled polypropylene.

13. The cowl trim of claim 11, wherein said cowl trim comprises talc-filled polypropylene.

14. The cowl trim of claim 11, wherein said cowl trim comprises a rear portion having a first boss proximate to said first aperture.

15. The cowl trim of claim 14, wherein said cowl trim comprises a second boss protruding from said rear portion proximate to said second aperture.

16. The cowl trim of claim 11, wherein said cowl trim further comprises at least one through hole, said through hole accepting a fastener for fastening said cowl trim to a front cowl of the golf car.

17. A golf car comprising:
a front cowl;
a cowl trim mounted to said front cowl, said cowl trim comprising:
a top portion;
a top flange of said top portion, said top flange in flexible contact with said front cowl;
a bottom portion opposite said top portion;
a first side portion rigidly mounted to said front cowl; and
a second side portion opposite said first side portion, said second side portion rigidly mounted to said front cowl; and
a headlight mounted to said cowl trim.

18. The golf car of claim 17, wherein said top flange comprises a rear flange extending from said top flange, said rear flange directly contacting said front cowl.

19. The golf car of claim 17, wherein said cowl trim comprises mineral filled polypropylene.

20. The golf car of claim 17, wherein said cowl trim comprises talc-filled polypropylene.
